(19) United States
(12) Patent Application Publication
(10) Pub. No.: US 2019/0190377 A1
(43) Pub. Date: Jun. 20, 2019

(54) Voltage Regulation with Frequency Control

(71) Applicant: Qualcomm Incorporated, San Diego, CA (US)

(72) Inventors: Orlando Santiago, San Diego, CA (US); Sugato Mukherjee, San Diego, CA (US); Todd Sutton, Del Mar, CA (US); Zdravko Lukic, San Diego, CA (US)

(21) Appl. No.: 16/228,652

(22) Filed: Dec. 20, 2018

Related U.S. Application Data
(60) Provisional application No. 62/608,560, filed on Dec. 20, 2017.

(51) Int. Cl. H02M 3/155

(52) U.S. Cl. CPC H02M 3/155; H02M 1/08

(57) ABSTRACT

Methods and apparatuses can implement voltage regulation with frequency control. In an example aspect, a voltage generator includes an output node and a switch. A voltage controller is coupled to the switch of the voltage generator. A mode controller is coupled to the voltage controller. The voltage controller is configured to control an output voltage at the output node by closing and opening the switch at a switching frequency. The voltage controller is configured to operate in multiple operational modes. The mode controller is configured to cause the voltage controller to shift between two or more operational modes responsive to the switching frequency. The switching frequency can be moved out of a rejection frequency band by shifting operational modes. Shifting can include, for example, shifting from a PFM mode to a PWM mode or shifting from one hysteresis mode to another hysteresis mode within the PFM mode.

### CROSS-REFERENCE TO RELATED APPLICATION(S)

This Application claims the benefit of U.S. Provisional Application No. 62/608,560, filed Dec. 20, 2017, the disclosure of which is hereby incorporated by reference in its entirety herein.

### TECHNICAL FIELD

This disclosure relates generally to providing power to integrated circuits (ICs) and other components that are used in electronic devices and, more specifically, to changing a switching frequency of a voltage regulator.

### BACKGROUND

Power consumption by electronic devices is an increasingly important factor in the design of electronic devices. From a global perspective, the energy consumption of electronic devices occupies a sizable percentage of total energy usage due to large corporate data centers and the ubiquity of personal computing devices. Environmental concerns thus motivate efforts to reduce the power consumed by electronic devices to help conserve the earth's resources. From an individual perspective, less power consumption translates to lower energy bills. Furthermore, many personal computing devices are portable and powered by batteries. The less energy that is consumed by a portable battery-powered electronic device, the longer the portable device can operate without recharging the battery. Lower energy consumption also enables the use of smaller batteries and the adoption of thinner form factors, which means electronic devices can be made more portable or versatile. Thus, the popularity of portable devices also motivates efforts to reduce the power consumption of electronic devices.

In modern electronic devices, a power management integrated circuit (PMIC) generates and provides voltages for different loads, such as a core of an integrated circuit or transceiver circuitry. With respect to powering an integrated circuit core, for example, the PMIC can be disposed on the same integrated circuit as the core or a different integrated circuit. The PMIC is responsible for providing a stable, steady voltage to the core to enable the core to operate properly. During standard operation or as part of a power-conserving strategy, the core can draw a load current that fluctuates over time. Nevertheless, a voltage regulator of the PMIC is expected to be able to maintain a regulated output voltage level as the load current changes over time.

A circuit load, such as a block or core of an integrated circuit, may receive power from a power rail of an integrated circuit. The power rail in turn receives power from a power regulator of the PMIC. To provide power, the power regulator establishes a supply voltage for the power rail that distributes the power to one or more circuit loads. In operation, the voltage regulator attempts to maintain the supply voltage at a stable level across different amounts of current drawn by the one or more circuit loads. Accordingly, engineers and other designers of electronic devices focus on designing voltage regulators that provide a reliable, stable output voltage while being mindful of power reduction opportunities.

### SUMMARY

Electronic devices, and the circuits thereof, operate more reliably if supplied with a stable voltage source. To provide stable power to a load, electronic devices employ voltage regulation circuitry to generate a relatively constant output voltage, even if a current drawn by the load fluctuates over time. An example of a voltage regulator is a switched-mode power supply (SMPS). An SMPS includes a switch that is operated at some switching frequency to provide the output voltage by turning current flow on and off. The switching on and off may generate electromagnetic interference (EMI) at the switching frequency. If another component of the electronic device is sensitive or susceptible to EMI at this switching frequency, reliable operation of the other component is jeopardized, and the other component may fail to function correctly.

To address this issue, voltage regulation with frequency control is described herein. Example implementations of voltage regulation circuitry include a voltage generator, a voltage controller, and a mode controller. The voltage generator includes a switch and an output node that provides an output voltage based at least partially on operation of the switch. The voltage controller opens and closes the switch at a switching frequency. The mode controller detects the switching frequency. The mode controller stores, receives, or otherwise has access to an error frequency for some component of an electronic device that is susceptible to failing if subjected to EMI at the error frequency. The voltage regulation circuitry can realize the error frequency as, for example, a rejection frequency band having a guard frequency range that covers the error frequency or an error frequency range corresponding to the problematic EMI.

If the switching frequency falls within the rejection frequency band, the mode controller directs the voltage controller to shift operational modes in a manner to change the switching frequency. For example, the switching frequency can be changed by shifting from a pulse-frequency modulation (PFM) mode to a non-PFM mode of operation. Example non-PFM modes include a pulse-width modulation (PWM) mode and a pulse-skipping mode. Further, within the PFM mode, the switching frequency can be changed by shifting from one hysteresis mode to another hysteresis mode, which adjusts a size of a voltage swing of the output voltage as well as an output frequency. In these manners, voltage regulation is enabled while spurious EMI that can negatively impact another component of an electronic device is mitigated.

In an example aspect, an apparatus is disclosed. The apparatus includes a voltage generator having an output node and a switch. The apparatus also includes a voltage controller coupled to the switch and a mode controller coupled to the voltage controller. The voltage controller is configured to control an output voltage at the output node by closing and opening the switch at a switching frequency. The voltage controller is configured to operate in multiple hysteresis modes. The mode controller is configured to cause the voltage controller to shift from a first hysteresis mode to a second hysteresis mode of the multiple hysteresis modes responsive to the switching frequency.

In an example aspect, an apparatus is disclosed. The apparatus includes generation means for generating a voltage at an output node using a switch. The apparatus also includes voltage control means for controlling an output voltage at the output node by operating the switch at a switching frequency in accordance with multiple hysteresis modes. The apparatus further includes mode control means for causing the voltage control means to shift from one hysteresis mode to another hysteresis mode of the multiple hysteresis modes responsive to the switching frequency.

In an example aspect, a method for voltage regulation with frequency control is disclosed. The method includes controlling a switch of a voltage generator in accordance with a first hysteresis mode. The method also includes generating, with the voltage generator, an output voltage using the switch controlled in accordance with the first hysteresis mode. The method additionally includes detecting a switching frequency of the switch and determining whether the detected switching frequency is within at least one rejection frequency band. The method also includes, responsive to the determining, shifting to a second hysteresis mode. The method further includes controlling the switch in accordance with the second hysteresis mode.

In an example aspect, an apparatus is disclosed. The apparatus includes a voltage generator having an output node and a switch. The apparatus also includes a voltage controller coupled to the switch via a switch control signal. The voltage controller is configured to control an output voltage at the output node by operating the switch at a switching frequency using the switch control signal. The apparatus further includes a mode controller coupled to the voltage controller. The mode controller includes a voltage detector configured to detect the switching frequency. The mode controller is configured to cause the voltage controller to shift from a first operational mode to a second operational mode responsive to the detected switching frequency.

### BRIEF DESCRIPTION OF DRAWINGS

FIG. 1 illustrates an example integrated circuit with a power management integrated circuit (PMIC) that includes voltage regulation circuitry.

FIG. 2-1 illustrates example voltage regulation circuitry, which includes a voltage generator, a voltage controller, and a mode controller, that can operate in accordance with multiple operational modes.

FIG. 2-2 is a flow diagram illustrating an example process for voltage regulation with frequency control.

FIG. 3 illustrates examples of a voltage generator, a voltage controller, and a mode controller that can jointly operate in accordance with multiple operational modes.

FIG. 4 illustrates an example voltage controller and an example mode controller that can direct a voltage generator to operate in accordance with multiple operational modes.

FIG. 5 depicts an example graph of switching frequency versus load current for two example hysteresis modes of voltage regulation circuitry that is operating in a pulse-frequency modulation (PFM) mode with a frequency rejection band.

FIG. 6 depicts another example graph of switching frequency versus load current for two example hysteresis modes of voltage regulation circuitry that is operating in a PFM mode with a relatively-wider frequency rejection band.

FIG. 7 is another flow diagram illustrating an example process for voltage regulation with frequency control.

FIG. 8 illustrates an example electronic device that includes an integrated circuit having a PMIC in which voltage regulation with frequency control can be implemented.

### DETAILED DESCRIPTION

In an electronic device, a power source, such as a power management integrated circuit (PMIC), provides a load current to a circuit load. The PMIC provides an output voltage at an output node, and the output node provides the load current to a core or other load based on the output voltage. Because loads operate more reliably with stable voltages, a PMIC typically includes a voltage regulator. The voltage regulator is intended to automatically maintain a substantially constant voltage level at the output node across different operating points of the load, such as across different magnitudes of load current being drawn by the load. An example of a voltage regulator is a switched-mode power supply (SMPS). An SMPS operates by opening and closing a switch to control when power is being forwarded to a load, such as by controlling whether or not a power delivery circuit of the voltage regulator is receiving additional current.

More specifically, a switch opens and closes with an SMPS to modulate current flow through a power delivery circuit and to maintain a desired voltage level at an output node of the SMPS. Typically, an SMPS operates the switch in one of two modulation modes: a pulse frequency modulation (PFM) mode or a pulse width modulation (PWM) mode. For the PWM mode, a width of time during which current flows from a power source toward the load can be adjusted each cycle to maintain a desired output voltage, but the cycle period remains substantially constant for some amount of time. With the PWM mode, the length of each cycle is fixed, so a frequency of the switching (e.g., a frequency at which the switch is closed to deliver current) is constant. For the PFM mode, in contrast, a frequency at which the switching occurs varies based on the load current. As a circuit load draws more current, the SMPS increases a frequency of the switching in the PFM mode. Hence, the frequency of the switching is variable with the PFM mode.

Straightforward implementations of the PWM and PFM modes have different strengths and weaknesses. For example, the PWM mode has a fixed, and therefore predictable, frequency of operation. A weakness, however, is that the efficiency of an SMPS that is operating in the PWM mode dramatically decreases as a current drawn by a circuit load decreases. This inefficiency arises because the load is not using an appreciable amount of current, but the power consumed by the switching continues unabated at the constant frequency level. In contrast, the efficiency of an SMPS that is operating in the PFM mode is relatively superior because as the current drawn by the circuit load decreases, the switching frequency likewise decreases. A weakness for a PFM mode of operation, however, is that the variable frequency of the switching may be unpredictable because the current drawn by the load can be variable.

This current variability and resulting lack of frequency predictability can cause havoc with other circuit components at certain frequencies, depending on the susceptibility of such circuit components to electromagnetic interference (EMI) caused by spurious signals at different frequencies. For example, a component of an electronic device, such as a display screen or a sensor, can fail to operate correctly or reliably when subjected to EMI of a particular frequency range. Biomedical devices and sensors, for instance, may have relatively lower signal amplitudes (e.g., in the microvolt (μV) range) or low-frequency-spectrum signaling. With an existing SMPS that is operating in a PFM mode, a variable load current can, at unpredictable times, cause the SMPS to switch at a frequency that is within the particular frequency range that is problematic. Based on EMI caused by the switching at this frequency, the component that is susceptible to the EMI can cease to function reliably or correctly, including when the component is needed.

To address these concerns, in some implementations, voltage regulation circuitry can attain the greater efficiency of the PFM mode over a wide range of load currents while mitigating the EMI risks associated with operating at unpredictable frequencies. To do so, the voltage regulation circuitry can function in multiple different operational modes. Operational modes can include PFM modes and non-PFM modes, which may include at least a PWM mode and a PS mode. Generally, if a load current causes a switching frequency to enter a rejection frequency band with a PFM mode, the voltage regulation circuitry can shift to a different operational mode, such as from the PFM mode to a non-PFM mode. Additionally or alternatively, the voltage regulation circuitry can shift between different hysteresis modes of a PFM mode, with each hysteresis mode corresponding to at least one different voltage switching threshold or reference voltage, such as an upper reference voltage or a lower reference voltage. The different voltage switching thresholds result in output voltage swings, which may be referred to as output voltage ripples, with different magnitudes or voltage ranges.

To configure the voltage regulation circuitry, at least one rejection frequency band is established that includes a frequency range (e.g., at least one frequency) that can jeopardize satisfactory operation of another component. If use of one operational mode causes the switching frequency of the SMPS to be within a rejection frequency band, operation of the SMPS is shifted to another operational mode. For example, if use of one hysteresis mode causes the switching frequency of operation of the SMPS to be within a rejection frequency band, operation of the SMPS is shifted to operate in accordance with another hysteresis mode. The other hysteresis mode likely moves the switching frequency of the SMPS out of the rejection frequency band. However, if no available hysteresis mode avoids the rejection frequency band, then the SMPS can be operated in a non-PFM mode, such as a PWM mode or a pulse-skipping mode (PS mode), until a timer expires or the load current changes. Generally, voltage regulation circuitry as described herein can utilize at least one hysteresis mode of a PFM mode and establish at least one rejection frequency band, but more can be utilized or established.

Thus, in example implementations, voltage regulation circuitry, such as an SMPS, is configured to shift between two or more operational modes for regulating an output voltage of the SMPS. The shifting can be performed responsive to a switching frequency of the SMPS and based on at least one rejection frequency band to move the switching frequency out of the rejection frequency band. For a given hysteresis mode, the switching frequency can change as a load current changes. Further, each hysteresis mode can correspond to a magnitude (e.g., a voltage range) of a voltage swing of the output voltage. The voltage swing results at least partly from upper and lower reference voltages of a given hysteresis mode that are coupled to a voltage comparator for comparison to the output voltage. Additionally or alternatively, the SMPS can shift between at least two hysteresis modes to avoid at least one rejection frequency band by comparing the switching frequency to a high frequency and a low frequency of the rejection frequency band. If the SMPS is operating in a PFM mode to utilize multiple hysteresis modes, the SMPS can be configured to change to a non-PFM mode (e.g., a PWM mode or a pulse-skipping mode) as a safeguard in case the SMPS is unable to shift to a hysteresis mode that removes the switching frequency from the rejection frequency band. Thus, voltage regulation circuitry as described herein can be configured to avoid interfering with components that are susceptible to certain frequencies of EMI while the voltage regulation circuitry still generally attains the relatively superior power efficiency of the PFM mode of operation.

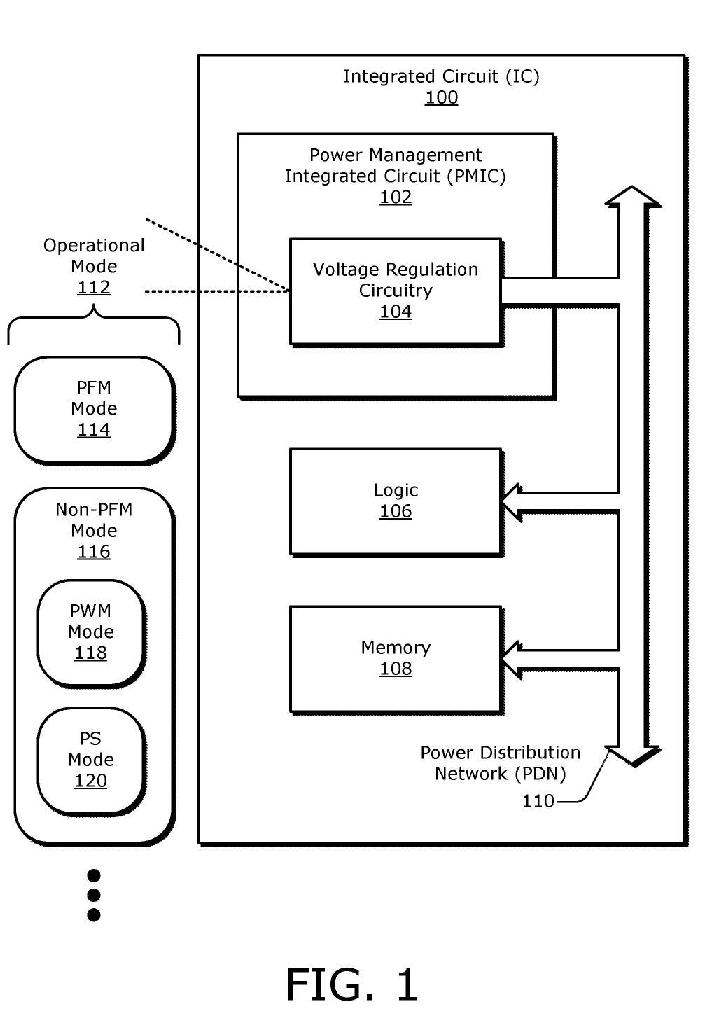

FIG. 1 illustrates an example integrated circuit 100 (IC) with a power management integrated circuit 102 (PMIC) that includes voltage regulation circuitry 104. As shown, the integrated circuit 100 also includes logic 106, memory 108, and a power distribution network 110 (PDN). The power management integrated circuit 102 provides power for the integrated circuit 100 and/or to other circuits external to the IC 100. For example, the power management integrated circuit 102 generates at least one voltage and supplies the voltage to other parts of the integrated circuit 100, such as one or more circuit loads. Examples of loads include the logic 106 and the memory 108; however, other numbers and types of loads may alternatively be implemented on the integrated circuit 100. For example, a load may include a component of a display screen, audio circuit, or sensor (or a sensor that is part of a display, such as a touchscreen). Frequencies discussed herein as potentially causing a problem may relate to certain frequencies that cause display flicker, audio artifacts (e.g., popping or clicking), and/or sensor error (e.g., failing to sense certain inputs, such as touch, sound, or visual inputs).

The voltage regulation circuitry 104 provides a supply voltage to the logic 106, the memory 108, and/or one or more other loads via the power distribution network 110. The voltage regulation circuitry 104 may therefore be coupled to the logic 106, the memory 108, or another load via the power distribution network 110. Alternatively, the voltage regulation circuitry 104 may be coupled to at least one load without using a power distribution network 110. Although shown as part of the same integrated circuit 100, the power management integrated circuit 102 or individual voltage regulation circuitry 104 may alternatively be disposed on an integrated circuit that is separate from the logic 106, the memory 108, or another load.

The logic 106 and the memory 108 are enabled to draw current via the supply voltage that is distributed by the power distribution network 110 to power logical and storage operations, respectively. The logic 106 and the memory 108 are expected to function within established specifications such that the components correctly provide the intended logical and storage functionality at a given operational clock frequency. To ensure that the logic 106, the memory 108, or another circuit load can function within prescribed specifications, the power management integrated circuit 102 is designed to provide a stable voltage level. The power management integrated circuit 102 is intended to provide a stable voltage level across different, changing current levels that are drawn by various loads. The logic 106, the memory 108, or another load may draw relatively higher magnitudes of current during periods of relatively higher utilization and relatively lower magnitudes of current at other times.

Thus, to supply a stable voltage level, the power management integrated circuit 102 uses the voltage regulation circuitry 104. The voltage regulation circuitry 104 is designed to provide a substantially steady output voltage for the power distribution network 110 across a range of currents drawn by different loads at different times. Further, the voltage regulation circuitry 104 is intended to maintain the steady output voltage as the currents drawn by loads disposed along the power distribution network 110 increase and decrease. Examples include the logic 106 or the memory 108 being powered down, a sensor being turned on or off, portions of the integrated circuit 100 entering a low-power or a sleep mode to reduce power consumption, another component engaging varying degrees of amplification, and so forth.

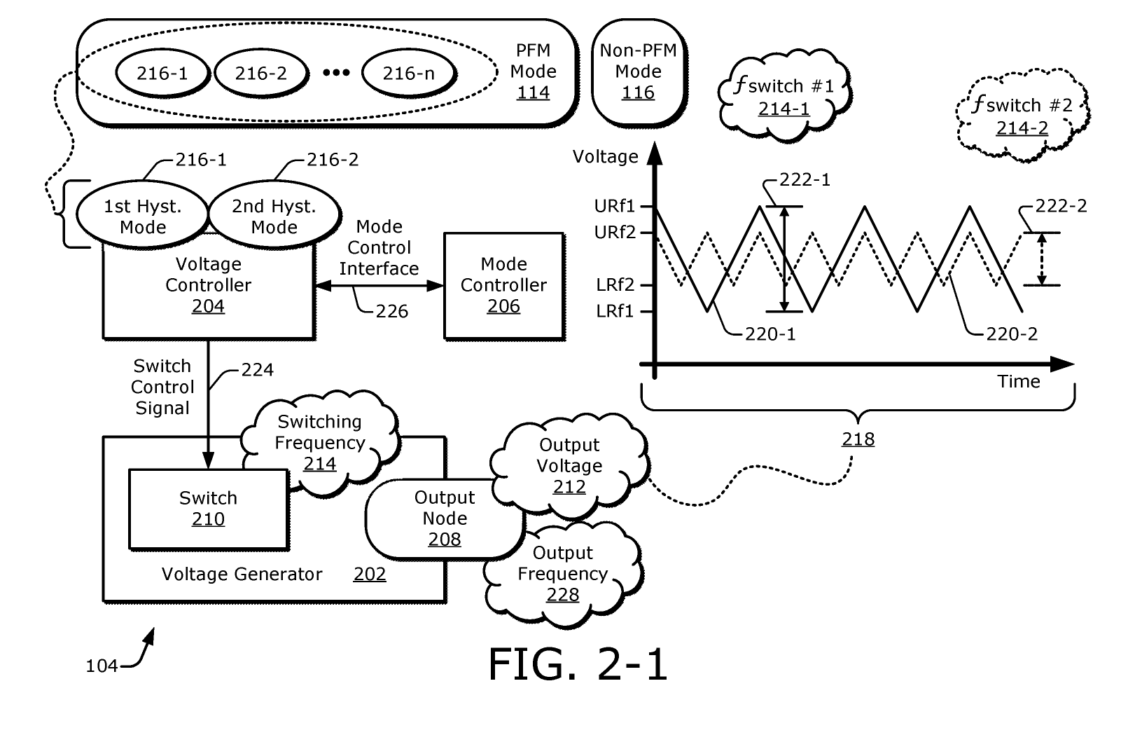

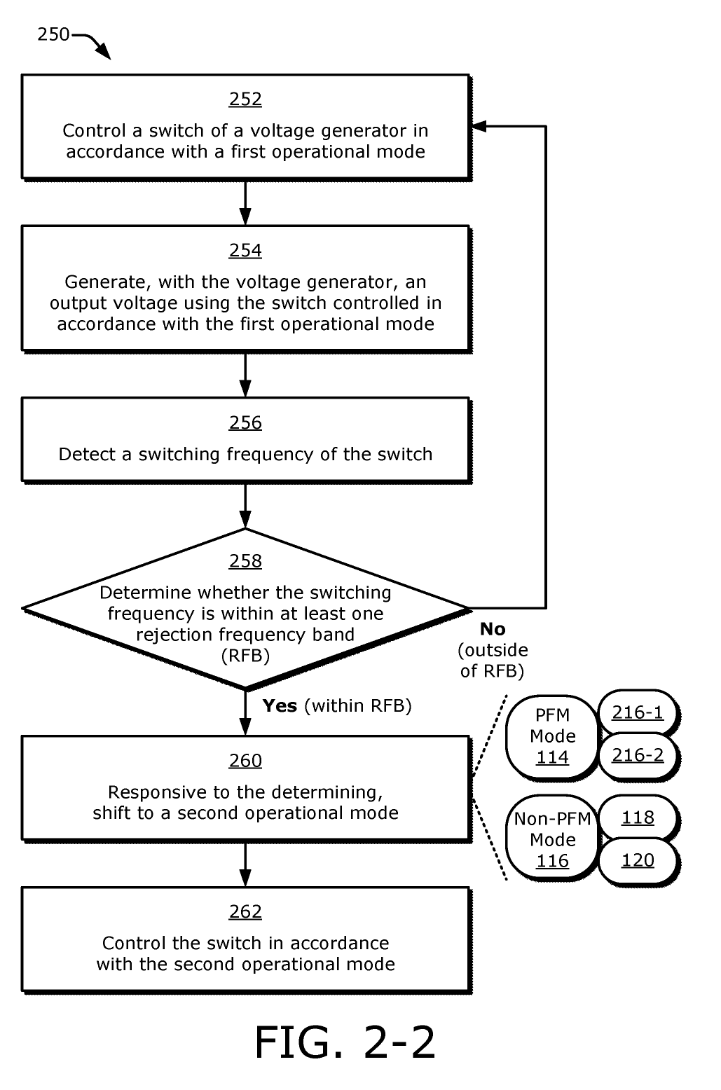

The voltage regulation circuitry 104 can operate in any one or more of multiple operational modes, which are depicted in FIG. 1 as an operational mode 112. Examples of an operational mode 112 include a pulse-frequency modulation (PFM) mode 114 (PFM mode 114), a non-PFM mode 116, and so forth. Examples of a non-PFM mode 116 include a pulse-width modulation (PWM) mode 118 (PWM mode 118), a pulse-skipping (PS) mode 120 (PS mode 120), and so forth. With the PFM mode 114, a switching frequency is unpredictable because it can depend on a current load. With a PWM mode 118, a switching frequency is predetermined, determined, or selectable, but efficiency can be lower than the PFM mode, at least for lower magnitude of load current. The PS mode 120 can result in a zero or negligible frequency across many different magnitudes of current load, but the efficiency can be lower still than the PWM mode 118. Thus, if an electronic device has one or more components that are susceptible to EMI at one or more frequencies, each of these modes offers to voltage regulation circuitry 104 a tradeoff between switching frequency versus efficiency. Example implementations of the voltage regulation circuitry 104 are described below, starting with reference to FIG. 2-1.

FIG. 2-1 illustrates example voltage regulation circuitry 104, which includes at least one voltage generator 202, at least one voltage controller 204, and at least one mode controller 206, that can operate in accordance with multiple operational modes. By way of example, at least one PFM mode 114 and at least one non-PFM mode 116 are depicted. As shown, the voltage generator 202 includes at least one output node 208 and at least one switch 210. A regulator controller for the voltage regulation circuitry 104 is separated into the voltage controller 204 and the mode controller 206. The voltage controller 204 is coupled to the switch 210. The mode controller 206 is coupled to the voltage controller 204. In operation, the voltage generator 202 provides an output voltage 212 at the output node 208. An example realization of the output voltage 212 is depicted by a graph 218, which is described below.

In example implementations, the voltage controller 204 is configured to control the output voltage 212 at the output node 208 by closing and opening the switch 210 at a switching frequency 214. The voltage controller 204 can control whether the switch 210 is in an open state versus a closed state via a switch control signal 224. If the switch 210 is in a closed state, current can flow through the switch 210 to the output node 208 to increase a level of the output voltage 212. On the other hand, if the switch 210 is in an open state, current does not flow through the switch 210 to the output node 208 to reinforce the level of the output voltage 212. Consequently, the output voltage 212 can fall if a load is drawing current from the output node 208 while the switch 210 is open.

The voltage controller 204 is configured to operate in multiple operating modes 112 (of FIG. 1), including the PFM mode 114 or the non-PFM mode 116 as explicitly depicted in FIG. 2-1. The PFM mode 114 can further include multiple hysteresis modes 216-1, 216-2 . . . 216-n, with “n” representing a positive integer. Thus, the voltage controller 204 can also operate in accordance with any of the multiple hysteresis modes 216-1 to 216-n. Each hysteresis mode 216 of the multiple hysteresis modes 216-1 . . . 216-n corresponds to a respective magnitude of a voltage swing of the output voltage 212. In the illustrated example, the voltage controller 204 can operate in at least a first hysteresis mode 216-1 and a second hysteresis mode 216-2. The mode controller 206 is operatively coupled to the voltage controller 204 via a mode control interface 226. The mode controller 206 is configured to cause the voltage controller 204 to shift from one operational mode to another operational mode, such as by shifting from the first hysteresis mode 216-1 to a second hysteresis mode 216-2 (or vice versa) of the multiple hysteresis modes 216-1 . . . 216-n to change the switching frequency 214. Also depicted is an output frequency 228 of the output voltage 212 at the output node 208. Generally, the switching frequency 214 is reflected at the output node 208 as the output frequency 228 with any differences caused by delays or jitter being relatively insignificant. Thus, the output frequency 228 of the output voltage 212 for a respective hysteresis mode 216 is substantially equivalent to the switching frequency 214 for the respective hysteresis mode 216. Accordingly, changes to the switching frequency 214 are reflected at the output node 208 as changes to the output frequency 228 of the output voltage 212. Changing the switching frequency 214 by shifting the hysteresis mode 216 is described with reference to the example graph 218.

In the graph 218, voltage is graphed versus time. As shown, multiple example output voltage waveforms are depicted, including a first output voltage waveform 220-1 (illustrated with a solid line) and a second output voltage waveform 220-2 (illustrated with a dashed line). Each output voltage waveform 220 corresponds to a respective voltage swing 222 and a respective output frequency. Thus, the first output voltage waveform 220-1 corresponds to a first voltage swing 222-1, and the second output voltage waveform 220-2 corresponds to a second voltage swing 222-2. The first output voltage waveform 220-1 results from the voltage controller 204 utilizing the first hysteresis mode 216-1, and the second output voltage waveform 220-2 results from the voltage controller 204 utilizing the second hysteresis mode 216-2. For each output voltage waveform 220, the voltage level is increasing responsive to the switch 210 being in a closed state, and the voltage level is decreasing responsive to the switch 210 being in an open state while a load draws a current. Thus, as shown for some implementations, each output voltage waveform 220 can be centered around a same voltage level and have a respective voltage swing 222 such that the resulting average voltage level is maintained across two or more hysteresis modes.

Each voltage swing 222 is associated with at least one reference voltage, such as an upper reference voltage (URf) and a lower reference voltage (LRf). The first voltage swing 222-1 is associated with a first upper reference voltage (URfl) and a first lower reference voltage (LRf1). The first voltage swing 222-1 is based on a difference (e.g., a voltage differential) between the first upper reference voltage (URf1) and the first lower reference voltage (LRf1). Similarly, the second voltage swing 222-2 is associated with a second upper reference voltage (URf2) and a second lower reference voltage (LRf2). The second voltage swing 222-2 is based on a difference (e.g., a voltage differential) between the second upper reference voltage (URf2) and the second lower reference voltage (LRf2). Although the second upper reference voltage (URf2) and the second lower reference voltage (LRf2) are shown as being “within” the bounds of the first upper reference voltage (URf1) and the first lower reference voltage (LRf1), the two voltage ranges may alternatively overlap instead of being nested. Further, two or more hysteresis modes may have a reference voltage in common with each other.

The two waveforms with the two different voltage swings have two different corresponding switching frequencies. As is depicted, a first period of the first output voltage waveform 220-1 is relatively larger or longer than a second period of the second output voltage waveform 220-2. Thus, a first switching frequency 214-1 corresponding to the first output voltage waveform 220-1 is a relatively lower frequency than a second switching frequency 214-2 corresponding to the second output voltage waveform 220-2.

In operation, the voltage controller 204 maintains the output voltage 212 between the first and second upper and lower reference voltages (between the URf1 and LRf1 and between the URf2 and LRf2) respectively responsive to the first hysteresis mode 216-1 and the second hysteresis mode 216-2 being active. Each hysteresis mode 216 of the multiple hysteresis modes 216-1 . . . 216-n therefore corresponds to a respective magnitude of a voltage swing 222 of the output voltage 212. With a smaller second voltage swing 222-2 as compared to the larger first voltage swing 222-1, the resulting second switching frequency 214-2 of the second output voltage waveform 220-2 is greater than the resulting first switching frequency 214-1 of the first output voltage waveform 220-1, at any given current draw by a load. Consequently, by shifting to a different hysteresis mode 216, which corresponds to a different voltage swing 222, the voltage controller 204 can change the switching frequency 214. In these manners, the voltage regulation circuitry 104 can move a switching frequency 214 out of a rejection frequency band that includes a frequency that is problematic for one or more components of an electronic device.

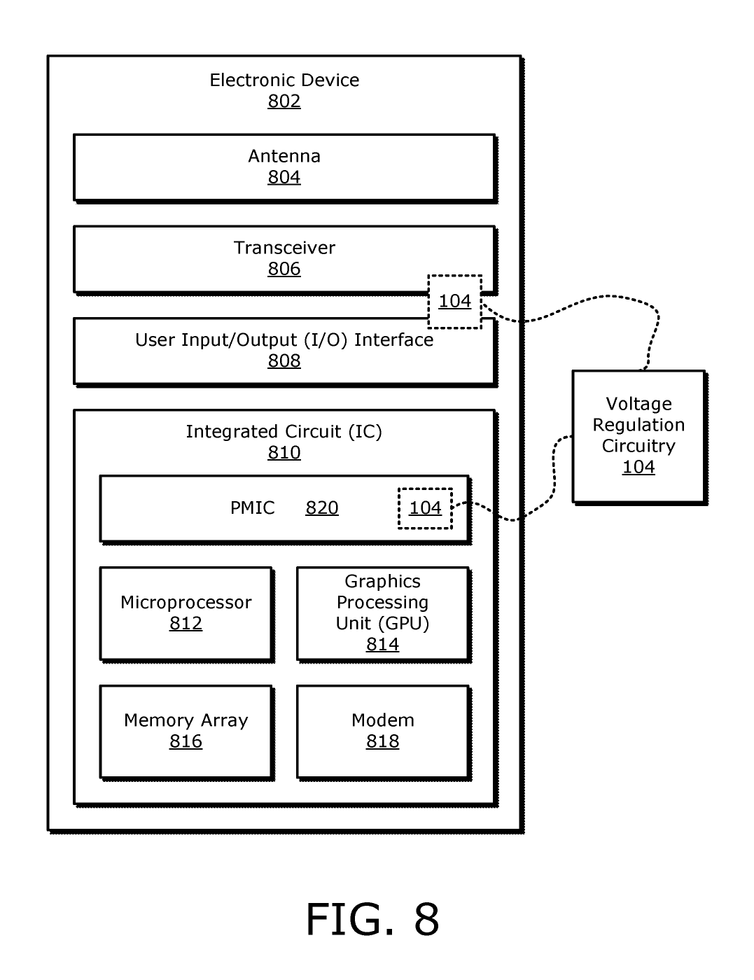

FIG. 2-2 is a flow diagram illustrating an example process 250 for voltage regulation with frequency control. The process 250 is described in the form of a set of blocks 252-262 that specify operations that can be performed. However, operations are not necessarily limited to the order shown in FIG. 2-2 or described herein, for the operations may be implemented in alternative orders or in fully or partially overlapping manners. Also, fewer, more, and/or different operations may be implemented to perform the process 250, or an alternative process. Operations represented by the illustrated blocks of the process 250 may be performed by an integrated circuit, such as the integrated circuit 100 of FIG. 1 or the integrated circuit 810 of FIG. 8, which is described below. More specifically, the operations of the process 250 may be performed by the power management integrated circuit 102 or 820 (of FIGS. 1 and 8, respectively), including the voltage regulation circuitry 104 thereof or separate voltage regulation circuitry 104.

At block 252, a switch of a voltage generator is controlled in accordance with a first operational mode. For example, voltage regulation circuitry 104 can control a switch 210 of a voltage generator 202 in accordance with a first operational mode, such as a PFM mode 114 having some hysteresis mode 216. For instance, a voltage controller 204 can cause the switch 210 to open and close in accordance with a first hysteresis mode 216-1. At block 254, with the voltage generator, an output voltage is generated using the switch controlled in accordance with the first operational mode. For example, the voltage regulation circuitry 104 can generate, with the voltage generator 202, an output voltage 212 using the switch 210 controlled in accordance with the PFM mode 114. Here, using the PFM mode 114, a switching frequency 214 of the switch 210 is at least partially dependent on a magnitude of a load current, and the switching frequency 214 is therefore variable.

At block 256, a switching frequency of the switch is detected. For example, the voltage regulation circuitry 104 can detect a first switching frequency 214-1 of the switch 210. This detection may be performed by a frequency detector 320 of a mode controller 206 based on operation of the voltage comparator 318 or by monitoring the output node 208. At block 258, it is determined whether the switching frequency is within at least one rejection frequency band (RFB). For example, the mode controller 206 of the voltage regulation circuitry 104 can determine whether the switching frequency 214 is within at least one rejection frequency band. To do so, a frequency analyzer 322 of the mode controller 206 may compare the detected switching frequency to frequencies within the rejection frequency band. If the detected switching frequency is outside of the rejection frequency band, the process 250 can continue at block 252. If, on the other hand, the detected switching frequency is within the rejection frequency band, the process 250 can continue at block 260.

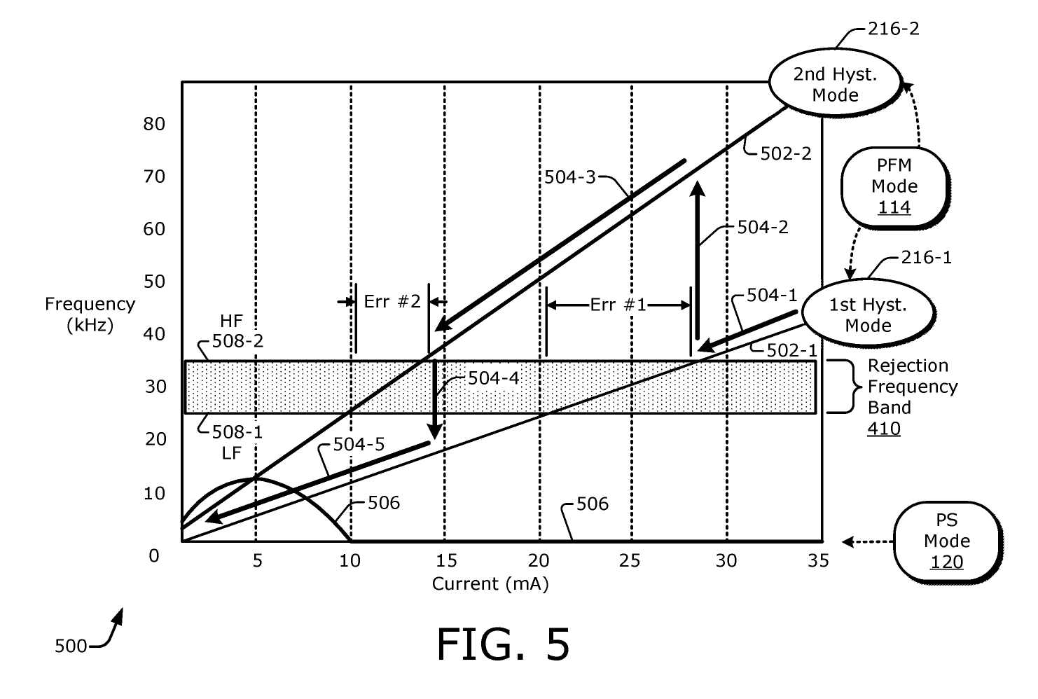

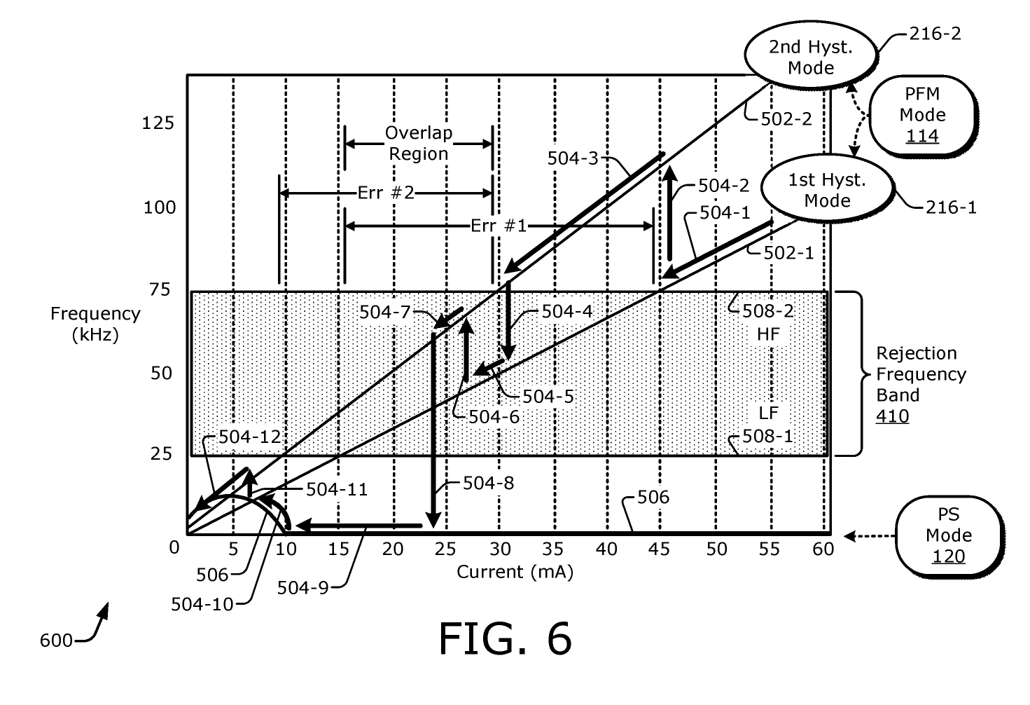

At block 260, responsive to an affirmative determination at block 258, operation is shifted to a second operational mode. For example, the voltage regulation circuitry 104 can shift from the PFM mode 114 to a second operational mode, such as a non-PFM mode 116, responsive to the determination that the switching frequency 214 is within the rejection frequency band. For instance, if the detected switching frequency is determined to fall within the rejection frequency band, the mode controller 206 can instruct the voltage controller 204 to switch to a PWM mode 118, which has a determinable frequency, or to a PS mode 120, which can have effectively zero frequency. Example switch frequency versus load current characteristics for a PS mode 120 is described below with reference to FIGS. 5 and 6. Alternatively, the mode controller 206 can cause the voltage controller 204 to shift from the first hysteresis mode 216-1 (of the PFM mode 114) to a second hysteresis mode 216-2 (of the PFM mode 114) to shift to the second operational mode. In other embodiments, instead of changing a hysteresis, e.g., by adjusting an upper and/or lower reference voltage as described herein, the mode controller 206 can cause the voltage controller 204 to shift to a second operational mode having a switching frequency 214 different than the first operational mode by changing a current limit (e.g., in the voltage controller 204) in a PFM mode 114.

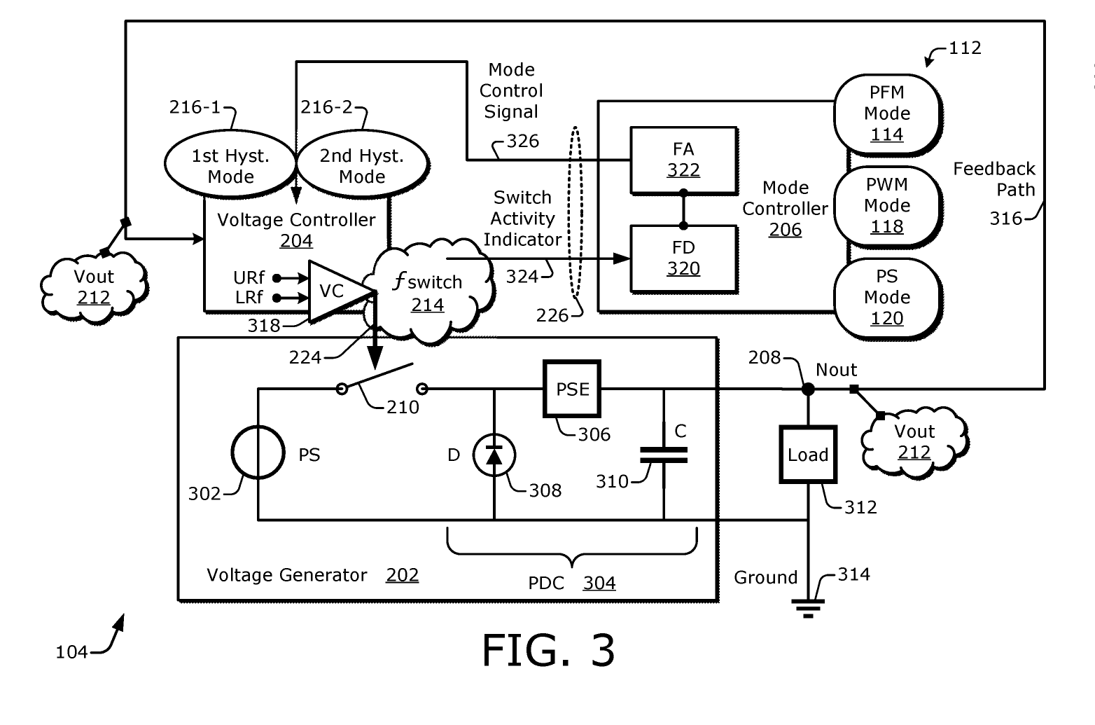

At block 262, the switch is controlled in accordance with the second operational mode. For example, the voltage regulation circuitry 104 can control the switch 210 in accordance with the second operational mode to move the switching frequency out of one or more rejection frequency bands. If the switch 210 is being operated in accordance with the non-PFM mode 116, then, after expiration of a timer or a detected change in load current, the mode controller 206 can shift back to the PFM mode 114 (e.g., to some hysteresis mode 216 thereof) to attain a higher efficiency level. Although some of the description of FIGS. 3-7 focuses on shifting between at least two hysteresis modes specifically, the described circuitries and principles are also applicable to shifting between at least two operational modes generally.

FIG. 3 illustrates examples of a voltage generator 202, a voltage controller 204, and a mode controller 206 that can jointly operate in accordance with multiple operational modes. Here, the voltage regulation circuitry 104 can be implemented as an example SMPS as indicated by the switch 210 of the voltage generator 202. As shown, the example voltage generator 202 includes a power source 302 (PS), the switch 210, and a power delivery circuit 304 (PDC). The power delivery circuit 304 includes a power storage element 306 (PSE), a diode 308 (D), and a capacitor 310 (C). However, the voltage generator 202 and/or the power delivery circuit 304 may include more, fewer, or different components.

In example implementations, the power storage element 306 is coupled together in series between the switch 210 and the output node 208 (Nout). A load 312 is coupled between the output node 208 (Nout) and a ground node 314. As shown, the power delivery circuit 304 of the voltage generator 202 may also include the diode 308 and the capacitor 310 coupled to opposite terminals of the power storage element 306. Specifically, the diode 308 is coupled between the ground 314 and a node that is common to the switch 210 and the power storage element 306. The capacitor 310 is coupled in parallel with the load 312 between the output node 208 and the ground node 314. The power storage element 306 can be implemented using, for example, an inductor. The switch 210 can be implemented using, for example, a transistor (not explicitly shown), such as a field effect transistor (FET). In some embodiments, the voltage regulation circuitry 104 illustrated in FIG. 3 can be implemented in a DC-to-DC buck converter.

In an example operation, power is supplied to the load 312 by closing the switch 210, which permits current to flow from the power source 302 into and through the power storage element 306. While the switch 210 is in a closed state, and current is flowing from the power source 302, the output voltage 212 (Vout) at the output node 208 is increasing (e.g., assuming that any current drawn by the load 312 is less than that supplied by the power source 302). On the other hand, while the switch 210 is in an open state, and current is not flowing from the power source 302 to the power storage element 306, the load 312 is drawing current from the capacitor 310 and/or the power storage element 306. Consequently, the output voltage 212 at the output node 208 is decreasing in this latter scenario. These rising and falling voltage levels are depicted in the first and second output voltage waveforms 220-1 and 220-2 of the graph 218 of FIG. 2.

In FIG. 3, a feedback path 316 is routed from the output node 208 to the voltage controller 204 to provide the output voltage 212 to the voltage controller 204 as part of a feedback control loop. The voltage controller 204 includes at least one voltage comparator 318 (VC). The mode controller 206 includes at least one frequency detector 320 (FD) and at least one frequency analyzer 322 (FA). The voltage controller 204 is configured to maintain the output voltage 212 within some voltage range using the voltage comparator 318. The voltage range extends from a lower voltage as the power source 302 ceases providing current and the load 312 draws down the stored current while the switch 210 is open to an upper voltage as the power source 302 provides current and the output voltage 212 increases while the switch 210 is closed.

As part of the feedback loop, the voltage comparator 318 compares the output voltage 212 obtained via the feedback path 316 to an upper reference voltage (URf) and a lower reference voltage (LRf). Based on an output of the voltage comparator 318, which output can be realized using the switch control signal 224, the voltage controller 204 opens and closes the switch 210 to keep the upper and lower extremes of the output voltage 212 at the output node 208 between the upper and lower reference voltages (URf and LRf). The range or voltage differential between the upper voltage level and the lower voltage level of the output voltage 212 at the output node 208 is referred to herein as a voltage swing (e.g., the voltage swing 222 of FIG. 2) and is also called an output voltage ripple. A magnitude of the voltage swing of the output voltage 212 is thus based on the upper and lower reference voltages (URf and LRf) that are currently being supplied to the voltage comparator 318.

The voltage controller 204 and the mode controller 206 are configured to operate in accordance with any of multiple different operational modes 112, such as a PFM mode 114, a PWM mode 118, or a PS mode 120. However, by way of example only, the voltage controller 204 is described with reference to FIG. 3 as implementing at least multiple hysteresis modes 216-1 . . . 216-n. Two example hysteresis modes are shown in FIG. 3: a first hysteresis mode 216-1 and a second hysteresis mode 216-2. Each respective hysteresis mode 216 has a different respective pair of upper and lower reference voltages (URf and LRf), one pair of which is explicitly depicted in FIG. 3. These different pairs of reference voltages for the voltage comparator 318 result in different voltage swings of the output voltage 212. The output voltage 212 is permitted to vacillate between different reference voltage levels with different corresponding voltage swing magnitudes by utilizing different hysteresis modes. Consequently, a respective switching frequency 214 for the switch 210 of the voltage regulator 202 is different for each respective hysteresis mode 216 of the multiple hysteresis modes 216-1 . . . 216-n, at a given current draw by the load 312.

For example, if a first hysteresis mode 216-1 causes a relatively larger magnitude for the first voltage swing 222-1 (of FIG. 2) at the output voltage 212, the first switching frequency 214-1 is relatively lower. Thus, there is relatively more slack in the control instituted by the feedback loop of the feedback path 316 for this first hysteresis mode 216-1. On the other hand, if a second hysteresis mode 216-2 causes a relatively smaller magnitude for the second voltage swing 222-2 at the output voltage 212, the second switching frequency 214-2 is relatively greater. Thus, there is relatively less slack in the control instituted by the feedback loop for this second hysteresis mode 216-2 in this example. Although only two hysteresis modes 216-1 and 216-2 are explicitly shown in FIG. 3, an SMPS can shift between more than two different hysteresis modes—e.g., can rotate through three different hysteresis modes to find one with an innocuous EMI frequency.

The mode controller 206 is configured to direct the voltage controller 204 to shift between different hysteresis modes while operating in the PFM mode. Further, the mode controller 206 is configured to direct the voltage controller 204 to change from the PFM mode to another, non-PFM mode, such as the PWM mode or the pulse-skipping mode, under certain conditions as is described herein. The mode controller 206 includes the frequency detector 320 and the frequency analyzer 322. The mode control interface 226 includes a switch activity indicator 324 and a mode control signal 326. The switch activity indicator 324 provides an indication of if, when, or how often the voltage controller 204 is causing the switch 210 to open or close. In example operations, the frequency detector 320 receives the switch activity indicator 324 from the voltage controller 204. Responsive to the switch activity indicator 324, the frequency detector 320 detects the switching frequency 214 of the switch 210. The frequency detector 320 can detect the switching frequency 214 using, for example, the voltage comparator 318, such as by being coupled to an output of the voltage comparator 318. Alternatively, the frequency detector 320 can be coupled to the output node 208 to detect the switching frequency 214 (e.g., via the output frequency 228 of FIG. 2).

The frequency detector 320 provides a detected frequency to the frequency analyzer 322. The frequency analyzer 322 analyzes the detected frequency to determine if the detected frequency is within a rejection frequency band (e.g., between a high frequency and a low frequency defining a rejection frequency band). Thus, the frequency analyzer 322 can include a frequency comparison circuit to compare the detected frequency to a high frequency threshold and a low frequency threshold. These thresholds can be fixed or can be settable/adjustable after manufacturing and/or after installation of the voltage regulation circuitry 104 into a larger component or an entire electronic device. Further, there can be multiple pairs of high/low frequency thresholds if the voltage regulation circuitry 104 implements multiple rejection frequency bands. If the frequency analyzer 322 determines that the detected frequency (e.g., an estimate of the switching frequency 214) is outside of a rejection frequency band, operation can continue with the current hysteresis mode 216. If, on the other hand, the detected switching frequency is within the rejection frequency band, the frequency analyzer 322 directs the voltage controller 204 to shift to another hysteresis mode (e.g., from a second hysteresis mode 216-2 to a first hysteresis mode 216-1) using the mode control signal 326. Alternatively, the frequency analyzer 322 can direct the voltage controller 204 to shift to a non-PFM mode 116, such as the PWM mode 118 or the PS mode 120, using the mode control signal 326.

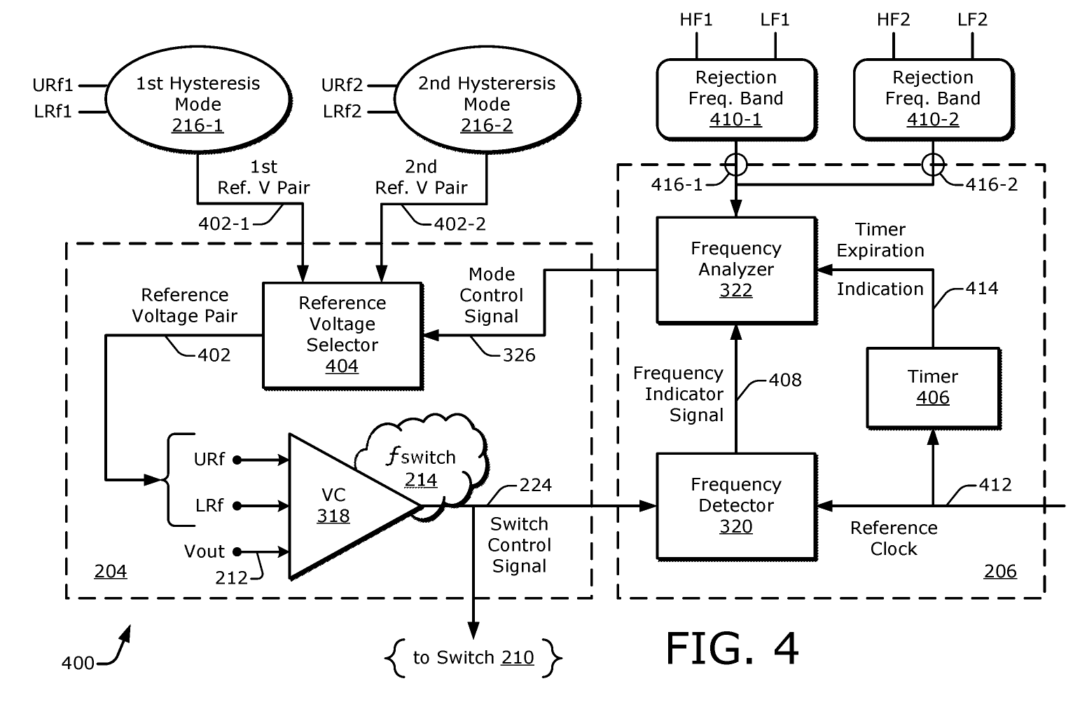

FIG. 4 illustrates, generally at 400, an example voltage controller 204 and an example mode controller 206 that can jointly direct a voltage generator 202 (of FIGS. 2 and 3) to operate in accordance with multiple operational modes. Although not explicitly depicted in FIG. 4, the voltage controller 204 and the mode controller 206 can also operate in accordance with any of the operational modes 112 that are described above with reference to FIGS. 1, 2-1, and 2-2. As illustrated in FIG. 4, the first hysteresis mode 216-1 is associated with the first upper reference voltage (URf1) and the first lower reference voltage (LRf1), which are jointly referred to as a first reference voltage pair 402-1 (“1st Ref V Pair”). The second hysteresis mode 216-2 is associated with the second upper reference voltage (URf2) and the second lower reference voltage (LRf2), which are jointly referred to as a second reference voltage pair 402-2 (“2nd Ref V Pair”). Alternatively, each hysteresis mode 216 can be associated with, or specified by, a voltage mean and a deviation from the mean. FIG. 4 also depicts at least one rejection frequency band 410, such as multiple rejection frequency bands 410-1 to 410-2. A first rejection frequency band 410-1 corresponds to a first high frequency (HF1) and a first low frequency (LF1), and a second rejection frequency band 410-2 corresponds to a second high frequency (HF2) and a second low frequency (LF2). Although two rejection frequency bands are shown in FIG. 4, voltage regulation circuitry 104 may alternatively operate with more or fewer rejection frequency bands, such as one or three. A rejection frequency band 410 may be established in different mariners. For example, in some cases, a rejection frequency band 410 may be explicitly input or otherwise specified to a mode controller 206 using a high frequency (HF) and a low frequency (LF) or using a middle frequency and a range from the middle frequency. In other cases, the mode controller 206 may compute a rejection frequency band 410 based on a specified error frequency or error frequency range, such as by adding a guard frequency range on both sides of the error frequency or error frequency range. The guard frequency range may be computed using an absolute frequency range (e.g., adding 5-10 kHz on both sides) or a relative frequency range (e.g., 10-20% of the error frequency added to each side to compute the rejection frequency band).

In example implementations, the voltage controller 204 includes a voltage comparator 318 and a reference voltage selector 404. The voltage comparator 318 receives as inputs an upper reference voltage (URf), a lower reference voltage (LRf), and the output voltage 212. The reference voltage selector 404 accepts as inputs the first reference voltage pair 402-1, the second reference voltage pair 402-2, and the mode control signal 326. Responsive to the mode control signal 326, the reference voltage selector 404 outputs a selected reference voltage pair 402 (e.g., the first reference voltage pair 402-1 or the second reference voltage pair 402-2). Here, each reference voltage pair 402 may differ from another reference voltage pair 402 by at least one reference voltage, such as by an upper reference voltage (URf) or a lower reference voltage (LRf) or both. The selected reference voltage pair 402 is provided as an input signal to the voltage comparator 318 as the upper reference voltage (URf) and the lower reference voltage (LRf). Alternatively, the voltage comparator 318 may include two or more voltage comparator circuits with each coupled to a respective reference voltage pair 402. In this case, the reference voltage selector 404 may select between the two or more voltage comparator circuits that each correspond to a respective reference voltage pair 402 responsive to the mode control signal 326.

In operation, the voltage comparator 318 compares the output voltage 212 to the upper reference voltage (URf) and the lower reference voltage (LRf). If the output voltage 212 falls below the lower reference voltage (LRf) or climbs above the upper reference voltage (URf), the voltage comparator 318 triggers the switch control signal 224 to switch a state of the switch 210. Thus, in this example, the switch activity indicator 324 (of FIG. 3) is implemented using the switch control signal 224. The frequency detector 320 receives the switch control signal 224 and a reference clock 412. The frequency detector 320 can count a number of transitions of the switch control signal 224 over some period of time using the reference clock 412. Based on this computed rate of transitions of the switch control signal 224, the frequency detector 320 detects the switching frequency 214. The frequency detector 320 forwards the detected switching frequency, which may comprise an estimate of the switching frequency 214, to the frequency analyzer 322 as a frequency indicator signal 408.

As shown, the mode controller 206 includes at least one rejection frequency input 416. For example, the mode controller 206 can include multiple rejection frequency inputs 416-1 to 416-2. A rejection frequency input 416 can be realized as multiple bits representing at least one frequency at an input to a circuit portion, an integrated circuit chip, a chip package, and so forth. Each rejection frequency input 416-1 and 416-2 corresponds to a respective rejection frequency band 410-1 and 410-2.

The mode controller 206 also includes at least one timer 406, which may track some period of time based on the reference clock 412 or a different clock. After expiration of the time period, the timer provides a timer expiration indication 414. In this example, the timer 406 provides the timer expiration indication 414 to the frequency analyzer 322. In some implementations, the frequency analyzer 322 (or the frequency detector 320) waits for expiration of a stabilizing time period for the switching frequency 214 to stabilize, such as after a shift from one hysteresis mode 216 to another hysteresis mode 216.

In operation, the frequency analyzer 322 compares the frequency indicator signal 408 to a high frequency (HF) and a low frequency (LF) of a rejection frequency band 410. If the frequency indicator signal 408 is between the high frequency (HF) and the low frequency (LF) of the rejection frequency band 410, the frequency analyzer 322 drives the mode control signal 326 to indicate to the reference voltage selector 404 to change hysteresis modes, which may include explicitly indicating which hysteresis mode 216 is to be in effect. For example, with two hysteresis modes, an active (e.g., high) mode control signal 326 can correspond to the second hysteresis mode 216-2, and an inactive (e.g., low) mode control signal 326 can correspond to the first hysteresis mode 216-1. If more than two hysteresis modes are being utilized, the mode control signal 326 can comprise more than one bit to inform the voltage controller 204 of which hysteresis mode 216 to shift to. If two rejection frequency bands, such as a first rejection frequency band 410-1 and a second rejection frequency band 410-2, are in effect, the frequency analyzer 322 can compare the frequency indicator signal 408 to each rejection frequency band 410. If the frequency indicator signal 408 falls within any specified rejection frequency band 410, the frequency analyzer 322 can change the mode control signal 326 accordingly to shift to another operational mode 112.

FIG. 5 depicts an example graph 500 of switching frequency versus load current for two example hysteresis modes of voltage regulation circuitry that is operating in a PFM mode with a frequency rejection band 410. The values for load currents (e.g., in milliamps (mA)) and switching frequencies (e.g., in kilohertz (kHz)) are provided by way of example only. An example rejection frequency band 410 is shown shaded between approximately 25 kHz for a low frequency (LF) at 508-1 and 35 kHz for a high frequency (HF) at 508-2. However, a rejection frequency band 410 can correspond to a different frequency range, have a wider frequency range, have a narrower frequency range, and so forth. A first hysteresis curve 502-1 and a second hysteresis curve 502-2 respectively correspond to the first hysteresis mode 216-1 and the second hysteresis mode 216-2 of a PFM mode 114.

In this example, the second hysteresis mode 216-2 is associated with a relatively higher switching frequency at any given current magnitude as compared to that of the first hysteresis mode 216-1 as indicated in the graph with the second hysteresis curve 502-2 having a steeper slope than the first hysteresis curve 502-1. With both hysteresis curves, the switching frequency decreases as the load current drops. A first current error range (“Err #1”) is depicted for the first hysteresis curve 502-1 between approximately 20 and 28 mA because the corresponding switching frequency of the first hysteresis mode 216-1 falls within the rejection frequency band 410. A second current error range (“Err #2”) is depicted for the second hysteresis curve 502-2 between approximately 10 and 14 mA because the corresponding switching frequency of the second hysteresis mode 216-2 falls within the rejection frequency band 410. Here, these two current error ranges do not overlap.

In the graph 500, multiple arrows are shown, with each arrow representing an example stage of an operation. As shown at a stage 504-1, as the load current decreases from 35 mA to 28 mA, the voltage generator 202 (of FIGS. 2 and 3) is operated in accordance with the first hysteresis mode 216-1, and the switching frequency falls from 45 kHz to 35 kHz. Thus, at a load current of about 28 mA, the switching frequency reaches 35 kHz, which corresponds to the high frequency (HF) of the rejection frequency band 410 at 508-2. The mode controller 206 therefore causes the voltage controller 204 to shift to the second hysteresis mode 216-2, which shift is indicated at a stage 504-2. The switching frequency therefore makes a quantized frequency jump (e.g., upwards leap) from about 35 kHz to 70 kHz, instead of tracking continuously along a hysteresis curve 502. For example, the switching frequency can make a quantized frequency jump if the frequency change is discontinuous at a given load current draw, if the frequency change is more than 5-10 kHz, if the frequency change is greater than 10-20% of the lesser of the two frequencies (e.g., the origin or the destination frequency), some combination thereof, and so forth.

As shown at a stage 504-3, the voltage generator 202 is operated in accordance with the second hysteresis mode 216-2. During this time, the load current continues to decrease, from 28 mA to 14 mA, and the switching frequency falls from 70 kHz to 35 kHz. The switching frequency has therefore again entered the rejection frequency band 410 by crossing below the high frequency (HF) at 508-2. To avoid the rejection frequency band 410, the mode controller 206 directs the voltage controller 204 to shift “back” to the first hysteresis mode 216-1, which is indicated by a stage 504-4. This causes the switching frequency to make another quantized frequency jump (e.g., downwards drop) to 18 kHz, which is outside of the rejection frequency band 410 (e.g., below the low frequency (LF) at 508-1). As shown at a stage 504-5, as the load current decreases from 14 mA to 0 mA, the frequency falls from 18 kHz to nearly 0 kHz along the first hysteresis curve 502-1 while operating using the first hysteresis mode 216-1. A pulse-skipping mode (PS mode 120), as represented by a pulse-skipping curve 506, is not utilized in this example, but the pulse-skipping curve 506 is utilized in an example described with reference to FIG. 6.

FIG. 6 depicts an example graph 600 of switching frequency versus load current for two example hysteresis modes of voltage regulation circuitry that is operating in a PFM mode with a frequency rejection band 410 that is relatively-wider as compared to that of FIG. 5. The values for load currents (in mA) and switching frequencies (in kHz) are provided by way of example only. An example rejection frequency band 410 is shown shaded between approximately 25 kHz for a low frequency (LF) at 508-1 and 75 kHz for a high frequency (HF) at 508-2. Thus, the rejection frequency band 410 is approximately five times wider as compared to that of FIG. 5. This contributes to creating an overlap current error region (“Overlap Region”) in which neither the switching frequency of the first hysteresis curve 502-1 of the first hysteresis mode 216-1 nor the switching frequency of the second hysteresis curve 502-2 of the second hysteresis mode 216-2 escapes the rejection frequency band 410. The overlap region (“Overlap Region”) corresponds to a range of current that overlaps the first current error range (“Err #1”) and the second current error range (“Err #2”) of the first and second hysteresis modes 216-1 and 216-2, respectively. An example approach to discovering and accommodating an overlap region is described next.

In example implementations, after one or more hysteresis mode shifts and/or waiting periods after a hysteresis mode shift, the mode controller ascertains that no available hysteresis mode can move the switching frequency out of the rejection frequency band 410 at a relevant (e.g., the “current” or instantaneous) load current magnitude. If the mode controller 206 determines that a number of unsuccessful mode shifts exceeds an unsuccessful number-of-shifts threshold or if some error timer threshold for being in the rejection frequency band 410 is met or expires, the mode controller 206 can determine to exit the PFM mode. For example, the mode controller 206 can change to a PWM mode 118 or a PS mode 120 to generate a low frequency or an effectively-no-frequency EMI condition, respectively.

With reference to FIG. 5, stages 504-1, 504-2, and 504-3 can occur analogously for the graph 600. At the stage 504-4 of FIG. 6, however, the shift “back” to the first hysteresis curve 502-1 does not remove the operational switching frequency from the rejection frequency band 410. After each shift to a different hysteresis mode 216 is made, a stabilization timer can be engaged (e.g., using the timer 406 of FIG. 4). Responsive to the timer expiration signal 414 being driven active by the timer 406, the frequency analyzer 322 determines if the switching frequency is present in the rejection frequency band 410. At the stage 504-5 in FIG. 6, the switching frequency is still within the rejection frequency band 410. Accordingly, the mode controller 206 causes another hysteresis mode shift at a stage 504-6 to cause the switching frequency to make another quantized frequency jump, which is to the second hysteresis curve 502-2 from the first hysteresis curve 502-1 at the stage 504-6.

At a stage 504-7, the stabilization timer starts anew. However, the switching frequency is still within the rejection frequency band 410 at the stage 504-7. Thus, each of the available hysteresis modes (two hysteresis modes in this example) have been tried without achieving a successful removal of the switching frequency from the rejection frequency band 410. If each available hysteresis mode 216 has been tried (or the attempts have reached some threshold number thereof), the mode controller 206 can cause the voltage regulation circuitry 104 to enter a non-PFM mode at a stage 504-8. Additionally or alternatively, if some maximum presence time in the rejection frequency band 410 is met (e.g., as tracked with another instance of the timer 406 of FIG. 4), the voltage regulation circuitry 104 can trigger entrance into a non-PFM mode. In the illustrated example, the voltage regulation circuitry 104 enters a PS mode 120 at the stage 504-8 as represented by the pulse-skipping curve 506. In the PS mode 120, pulses can be skipped to keep supplying current to a power delivery circuit (e.g., the power delivery circuit 304). This can reduce the switching frequency substantially to zero, as indicated at a stage 504-9. As indicated at a stage 504-10, if the load current draw becomes too low, some switching is reinitiated for the PS mode 120.

While in the PS mode 120 (or another non-PFM mode 116), the mode controller 206 can implement a mode timer (e.g., using another instance of the timer 406 of FIG. 4). After the mode timer expires, in an attempt to return to the PFM mode, the mode controller 206 changes “back” to the PFM mode and utilizes a hysteresis mode 216 thereof. This is indicated at a stage 504-11 with a change to the second hysteresis mode 216-2. The voltage regulation circuitry 104 can then continue operating along the second hysteresis curve 502-2 as shown at a stage 504-12. If more than one rejection frequency band 410 is realized, repeated quantized frequency jumps may still fail to move a switching frequency out of impermissible frequencies if the jumps are between two different rejection frequency bands. Thus, this situation can also trigger a change to a non-PFM mode even if each individual rejection frequency band 410 is relatively narrow.

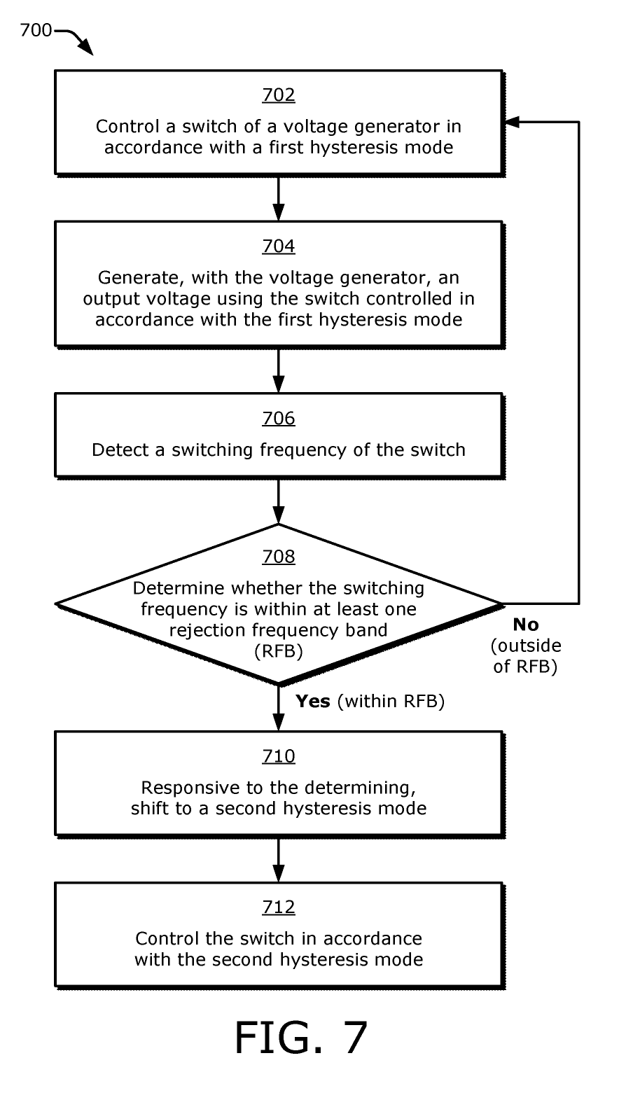

FIG. 7 is a flow diagram illustrating an example process 700 for voltage regulation with frequency control. The process 700 is described in the form of a set of blocks 702-712 that specify operations that can be performed. However, operations are not necessarily limited to the order shown in FIG. 7 or described herein, for the operations may be implemented in alternative orders or in fully or partially overlapping manners. Also, fewer, more, and/or different operations may be implemented to perform the process 700, or an alternative process. Operations represented by the illustrated blocks of the process 700 may be performed by an integrated circuit, such as the integrated circuit 100 of FIG. 1 or the integrated circuit 810 of FIG. 8, which is described below. More specifically, the operations of the process 700 may be performed by the power management integrated circuit 102 or 820 (of FIGS. 1 and 8), including the voltage regulation circuitry 104 thereof or separate voltage regulation circuitry 104.

At block 702, a switch of a voltage generator is controlled in accordance with a first hysteresis mode. For example, voltage regulation circuitry 104 can control a switch 210 of a voltage generator 202 in accordance with a first hysteresis mode 216-1. For instance, a voltage controller 204 may cause the voltage generator 202 to adhere to a first hysteresis curve 502-1 corresponding to the first hysteresis mode 216-1 as load current changes.

At block 704, with the voltage generator, an output voltage is generated using the switch controlled in accordance with the first hysteresis mode. For example, the voltage regulation circuitry 104 can generate, with the voltage generator 202, an output voltage 212 using the switch 210 controlled in accordance with the first hysteresis mode 216-1. The voltage controller 204 may use a voltage comparator 318 to cause the output voltage 212 to remain between a first upper reference voltage (URf1) and a first lower reference voltage (LRf1) of a first reference voltage pair 402-1 corresponding to the first hysteresis mode 216-1. Thus, the output voltage 212 may exhibit a first voltage swing 222-1 at a frequency that is dependent on a first switching frequency 214-1 of the switch 210.

At block 706, a switching frequency of the switch is detected. For example, the voltage regulation circuitry 104 can detect a first switching frequency 214-1 of the switch 210. This detection may be performed by a frequency detector 320 of a mode controller 206 based on operation of the voltage comparator 318, such as responsive to a switch control signal 224 that is output by the voltage comparator 318.

At block 708, it is determined whether the switching frequency is within at least one rejection frequency band. For example, the voltage regulation circuitry 104 can determine whether the switching frequency 214 is within at least one rejection frequency band 410. To do so, a frequency analyzer 322 of the mode controller 206 may compare the detected switching frequency to at least one rejection frequency band 410 to determine if the detected switching frequency is between a high frequency (HF) and a low frequency (LF) thereof. If the detected switching frequency is outside of the rejection frequency band 410, the process 700 can continue at block 702. If, on the other hand, the detected switching frequency is within the rejection frequency band 410, the process 700 can continue at block 710.

At block 710, responsive to the determination, operation is shifted to a second hysteresis mode. For example, the voltage regulation circuitry 104 can shift to a second hysteresis mode 216-2 responsive to the determination of whether the switching frequency 214 is within the rejection frequency band 410. For instance, if the detected switching frequency is determined to fall within the rejection frequency band 410, the mode controller 206 can instruct the voltage controller 204 to switch from the first hysteresis mode 216-1 to a second hysteresis mode 216-2, which is associated with a second upper reference voltage (URf2) and a second lower reference voltage (LRf2). This shift may cause a quantized frequency jump from the first hysteresis curve 502-1 to a second hysteresis curve 502-2 of the second hysteresis mode 216-2 at a given load current draw, which results in a different switching frequency 214 at the given load current draw.

At block 712, the switch is controlled in accordance with the second hysteresis mode. For example, the voltage regulation circuitry 104 can control the switch 210 in accordance with the second hysteresis mode 216-2. For instance, the voltage controller 204 may cause the voltage generator 202 to adhere to the second hysteresis curve 502-2 corresponding to the second hysteresis mode 216-2 as load current changes. Based on the second upper reference voltage (URf2) and the second lower reference voltage (LRf2), the second hysteresis mode 216-2 corresponds to a second voltage swing 222-2 of the output voltage 212, or second output voltage ripple, which differs from that of the first hysteresis mode 216-1.

FIG. 8 depicts an example electronic device 802 that includes an integrated circuit 810 (IC) having a power management integrated circuit 820 (PMIC) and multiple cores. As shown, the electronic device 802 includes an antenna 804, a transceiver 806, and a user input/output (I/O) interface 808 in addition to the integrated circuit 810. Illustrated examples of the integrated circuit 810, or cores thereof, include a microprocessor 812, a graphics processing unit 814 (GPU), a memory array 816, and a modem 818. In one or more example implementations, voltage regulation techniques as described herein can be implemented by the power management integrated circuit 820. For example, the power management integrated circuit 820 can include voltage regulation circuitry 104 that implements voltage regulation with frequency control. Additionally or alternatively, voltage regulation circuitry 104 can be included proximate to or coupled to other components of the electronic device 802, such as the transceiver 806 or the user input/output interface 808.

The electronic device 802 can be realized as a mobile or battery-powered device or a fixed device that is designed to be powered by an electrical grid. Examples of the electronic device 802 include a server computer, a network switch or router, a blade of a data center, a personal computer, a desktop computer, a notebook or laptop computer, a tablet computer, a smart phone, an entertainment appliance, a medical device (e.g., a biomedical device), a device configured to operate within a network of internet of things (IoT) devices, or a wearable computing device such as a smartwatch, intelligent glasses, or an article of clothing An electronic device 802 can also be a device, or a portion thereof, having embedded electronics. Examples of the electronic device 802 with embedded electronics include a passenger vehicle, industrial equipment, a refrigerator or other home appliance, a drone or other unmanned aerial vehicle (UAV), or a power tool.

For an electronic device with a wireless capability, the electronic device 802 includes an antenna 804 that is coupled to a transceiver 806 to enable reception or transmission of one or more wireless signals. The integrated circuit 810 may be coupled to the transceiver 806 to enable the integrated circuit 810 to have access to received wireless signals or to provide wireless signals for transmission via the antenna 804. The electronic device 802 as shown also includes at least one user I/O interface 808. Examples of the user I/O interface 808 include a keyboard, a mouse, a microphone, a touch-sensitive screen, a camera, an accelerometer, a haptic mechanism, a speaker, a display screen, or a projector.

The integrated circuit 810 may comprise, for example, at least one power management integrated circuit 820 and one or more instances of a microprocessor 812, a GPU 814, a memory array 816, a modem 818, and so forth. The microprocessor 812 may function as a central processing unit (CPU) or other general-purpose processor. Some microprocessors include different parts, such as multiple processing cores, that may be individually powered on or off. The GPU 814 may be especially adapted to process visual-related data for display. If visual-related data is not being rendered or otherwise processed, the GPU 814 may be fully or partially powered down. The memory array 816 stores data for the microprocessor 812 or the GPU 814. Example types of memory for the memory array 816 include random access memory (RAM), such as dynamic RAM (DRAM) or static RAM (SRAM); flash memory; and so forth. If programs are not accessing data stored in memory, the memory array 816 may be powered down overall or block-by-block. The modem 818 demodulates a signal to extract encoded information or modulates a signal to encode information into the signal.

If there is no information to decode from an inbound communication or to encode for an outbound communication, the modem 818 may be idled to reduce power consumption. The integrated circuit 810 may include additional or alternative parts than those that are shown, such as an I/O interface, a sensor such as an accelerometer or gyroscope, a transceiver or another part of a receiver chain, a customized or hard-coded processor such as an application-specific integrated circuit (ASIC), and so forth.

The integrated circuit 810 may also comprise a system on a chip (SOC). An SOC may integrate a sufficient number of different types of components to enable the SOC to provide computational functionality as a notebook computer, a mobile phone, an IoT device, or another electronic apparatus using one chip, at least primarily. Components of an SOC, or an integrated circuit 810 generally, may be termed cores or circuit blocks. A core or circuit block of an SOC may be powered down if not in use, such as by decreasing or ceasing a load current draw, and the power management integrated circuit 820 may accommodate the resulting varied and repetitive changes to the load current being drawn according to the techniques described in this document. Examples of cores or circuit blocks include, in addition to those that are illustrated in FIG. 8, a voltage regulator, a main memory or cache memory block, a memory controller, a general-purpose processor, a cryptographic processor, a video or image processor, a vector processor, a radio, an interface or communications subsystem, a wireless controller, or a display controller. Any of these cores or circuit blocks, such as a processing or GPU core, may further include multiple internal cores or circuit blocks.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An apparatus comprising:
a voltage generator including an output node and a switch;
a voltage controller coupled to the switch, the voltage controller configured to control an output voltage at the output node by closing and opening the switch at a switching frequency, the voltage controller configured to operate in multiple hysteresis modes; and
a mode controller coupled to the voltage controller, the mode controller configured to cause the voltage controller to shift from a first hysteresis mode to a second hysteresis mode of the multiple hysteresis modes responsive to the switching frequency.

2. The apparatus of claim 1, wherein each hysteresis mode of the multiple hysteresis modes corresponds to a respective magnitude of a voltage swing of the output voltage.

3. The apparatus of claim 1, wherein the mode controller includes a frequency detector configured to detect the switching frequency.

4. The apparatus of claim 3, wherein each hysteresis mode of the multiple hysteresis modes corresponds to a respective output frequency of the output voltage at a given magnitude of a current drawn by a load coupled to the output node.

5. The apparatus of claim 4, wherein each respective output frequency of the output voltage for a respective hysteresis mode is substantially equivalent to the switching frequency for the respective hysteresis mode.

6. The apparatus of claim 1, wherein the mode controller is configured to cause the voltage controller to shift from the first hysteresis mode to the second hysteresis mode to change the switching frequency by a quantized frequency jump.

7. The apparatus of claim 1, wherein the mode controller is configured to cause the voltage controller to shift from the first hysteresis mode to the second hysteresis mode responsive to the switching frequency and based on at least one rejection frequency band.

8. The apparatus of claim 7, wherein the at least one rejection frequency band corresponds to a high frequency and a low frequency.

9. The apparatus of claim 7, wherein:
the at least one rejection frequency band comprises two or more rejection frequency bands;
the mode controller is configured to cause the voltage controller to shift from the first hysteresis mode to the second hysteresis mode responsive to the switching frequency being within at least one of the two or more rejection frequency bands; and
the mode controller is configured to accept an input to establish the at least one rejection frequency band.

10. The apparatus of claim 1, wherein the mode controller is configured to cause the voltage controller to change the switching frequency by adjusting a magnitude of a voltage swing of the output voltage responsive to a change in a magnitude of a current drawn by a load coupled to the output node.

11. The apparatus of claim 10, wherein:
the first hysteresis mode corresponds to a first hysteresis curve of a switching frequency versus a load current, with the first hysteresis curve having a first slope;
the second hysteresis mode corresponds to a second hysteresis curve of the switching frequency versus the load current, with the second hysteresis curve having a second slope; and
the mode controller is configured to cause the voltage controller to shift operation from the first hysteresis mode to the second hysteresis mode responsive to the switching frequency being located along the first hysteresis curve and within a rejection frequency band.

12. The apparatus of claim 1, wherein:
the voltage controller includes a voltage comparator; and
each hysteresis mode of the multiple hysteresis modes respectively corresponds to an upper reference voltage and a lower reference voltage for the voltage comparator.

13. The apparatus of claim 12, wherein the mode controller includes a frequency detector configured to detect the switching frequency based on operation of the voltage comparator.

14. The apparatus of claim 13, wherein:
the mode controller includes a frequency analyzer coupled to the frequency detector; and
the frequency analyzer is configured to generate a mode control signal to control the shift from the first hysteresis mode to the second hysteresis mode responsive to the switching frequency and based on a rejection frequency band.

15. The apparatus of claim 1, wherein the mode controller is configured to shift from the first hysteresis mode to the second hysteresis mode to move the switching frequency out of at least one rejection frequency band.

16. The apparatus of claim 15, wherein the mode controller is configured to change operation from a pulse frequency modulation (PFM) mode to a non-PFM mode responsive to the switching frequency being within the at least one rejection frequency band for both the first hysteresis mode and the second hysteresis mode.

17. The apparatus of claim 16, wherein the non-PFM mode includes at least one of a pulse width modulation (PWM) mode and a pulse-skipping mode.

18. The apparatus of claim 15, wherein:
the apparatus comprises a power management integrated circuit (PMIC); and
the PMIC includes voltage regulation circuitry comprising the voltage generator, the voltage controller, and the mode controller.

19. The apparatus of claim 18, further comprising:
a transceiver; and
a display screen, wherein the PMIC is coupled to at least one of the transceiver or the display screen; and
the voltage regulation circuitry is configured to provide power to at least one of the transceiver or the display screen.

20. The apparatus of claim 18, wherein:
the voltage regulation circuitry comprises a switched-mode power supply (SMPS) configured to generate electromagnetic interference (EMI) as a result of the switching frequency; and
the apparatus further comprises at least one component that is susceptible to problematic operation if subjected to EMI having a frequency in the at least one rejection frequency band.

21. An apparatus comprising:
generation means for generating a voltage at an output node using a switch;
voltage control means for controlling an output voltage at the output node by operating the switch at a switching frequency in accordance with multiple hysteresis modes; and
mode control means for causing the voltage control means to shift from one hysteresis mode to another hysteresis mode of the multiple hysteresis modes responsive to the switching frequency.

22. The apparatus of claim 21, wherein:
the voltage control means comprises voltage comparison means for comparing the output voltage to an upper reference voltage and a lower reference voltage; and
the voltage control means is configured to use a different value for at least one of the upper reference voltage or the lower reference voltage based on a respective hysteresis mode of the multiple hysteresis modes in which the voltage control means is operating.

23. The apparatus of claim 21, wherein:
the mode control means comprises:
means for detecting the switching frequency to produce a frequency indicator signal; and
means for analyzing the frequency indicator signal relative to at least one rejection frequency band to produce a mode control signal; and
the voltage control means is configured to shift from the one hysteresis mode to the other hysteresis mode responsive to the mode control signal to change the switching frequency.

24. A method comprising:
controlling a switch of a voltage generator in accordance with a first hysteresis mode;
generating, with the voltage generator, an output voltage using the switch controlled in accordance with the first hysteresis mode;
detecting a switching frequency of the switch;
determining whether the switching frequency is within at least one rejection frequency band;
responsive to the determining, shifting to a second hysteresis mode; and
controlling the switch in accordance with the second hysteresis mode.

25. The method of claim 24, wherein the shifting comprises adjusting at least one of an upper reference voltage or a lower reference voltage used for a voltage comparison with the output voltage.

26. The method of claim 24, wherein:
the generating the output voltage using the switch controlled in accordance with the first hysteresis mode includes producing the output voltage to have a first voltage swing; and
the method further comprises generating, with the voltage generator, the output voltage using the switch controlled in accordance with the second hysteresis mode, including producing the output voltage to have a second voltage swing.

27. The method of claim 24, wherein the shifting comprises causing the switching frequency to jump from one frequency that is within the rejection frequency band to another frequency that is outside of the rejection frequency band.

28. An apparatus comprising:
a voltage generator including an output node and a switch;
a voltage controller coupled to the switch via a switch control signal, the voltage controller configured to control an output voltage at the output node by operating the switch at a switching frequency using the switch control signal; and
a mode controller coupled to the voltage controller, the mode controller including a frequency detector configured to detect the switching frequency, the mode controller configured to cause the voltage controller to shift from a first operational mode to a second operational mode responsive to the detected switching frequency.

29. The apparatus of claim 28, wherein:
the first operational mode comprises a pulse-frequency modulation (PFM) mode; and
the second operational mode comprises a non-PFM mode.

30. The apparatus of claim 28, wherein:
the first operational mode comprises a first hysteresis mode; and
the second operational mode comprises a second hysteresis mode.
